(19) United States
(12) Patent Application Publication
(10) Pub. No.: US 2022/0293117 A1
(43) Pub. Date: Sep. 15, 2022

(54) SYSTEMS AND METHODS FOR TRANSFORMING AUDIO IN CONTENT ITEMS

(71) Applicant: Meta Platforms, Inc., Menlo Park, CA (US)

(72) Inventor: Sammy El Ghazzal, Oberengstringen (CH)

(21) Appl. No.: 17/201,592

(22) Filed: Mar. 15, 2021

(51) Int. Cl. G10L 21/013; G06N 20/00

(52) U.S. Cl. CPC G10L 21/013; G06N 20/00; G10L 2021/0135; G10L 25/18

(57) ABSTRACT

Systems, methods, and non-transitory computer-readable media can be configured to obtain source audio based on recorded audio. A tuned audio transform can be generated based on a source audio transform corresponding to the source audio and a recorded audio transform corresponding to the recorded audio. Tuned audio can be generated based on the tuned audio transform.

### FIELD OF THE INVENTION

The present technology relates to the field of digital communications. More particularly, the present technology relates to processing of audio content.

### BACKGROUND

Today, people often utilize computing devices (or systems) for a wide variety of purposes. For example, users can utilize computing devices to access a social networking system (or service). The users can utilize the computing devices to interact with one another, share content items, and view content items via the social networking system. For example, a user may share a content item, such as an image, a video, an article, or a link, via a social networking system. Other users may access the social networking system and interact with the shared content item.

### SUMMARY

Various embodiments of the present technology can include systems, methods, and non-transitory computer readable media configured to obtain source audio based on recorded audio. A tuned audio transform can be generated based on a source audio transform corresponding to the source audio and a recorded audio transform corresponding to the recorded audio. Tuned audio can be generated based on the tuned audio transform.

In an embodiment, a first machine learning model can be trained based on training data including recorded audio transforms and source audio transforms. The generating the tuned audio transform can be based on the first machine learning model applied to the source audio transform and the recorded audio transform.

In an embodiment, the training the first machine learning model can be based on a reduction in distance between the recorded audio transforms and the source audio transforms in an embedding space.

In an embodiment, a second machine learning model can be trained based on training data including source audio transforms and source audio associated with the source audio transforms. The generating the tuned audio can be based on the second machine learning model applied to the tuned audio transform.

In an embodiment, the training the second machine learning model can be further based on an attribute associated with the source audio, wherein the attribute includes at least one of: an artist, a genre, or a musical style.

In an embodiment, the generating the tuned audio can be further based on the attribute.

In an embodiment, the determining the source audio can include determining a portion of the source audio that aligns with the recorded audio.

In an embodiment, the determining the source audio can be further based on metadata associated with the recorded audio.

In an embodiment, the metadata is associated with one or more of a song name, an album, a musical genre, lyrics, or an artist associated with the source audio.

In an embodiment, the tuned audio is based on the recorded audio tuned to a key of the source audio.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the present technology.

### BRIEF DESCRIPTION OF THE DRAWINGS

FIG. 1 illustrates an example system including an audio fixer module, according to an embodiment of the present technology.

FIG. 2 illustrates an example functional block diagram, according to an embodiment of the present technology.

FIG. 3 illustrates an example functional block diagram, according to an embodiment of the present technology.

FIGS. 4A-4B illustrate example interfaces, according to an embodiment of the present technology.

FIG. 5A-5B illustrate example methods, according to an embodiment of the present technology.

FIG. 6 illustrates a network diagram of an example system including an example social networking system that can be utilized in various scenarios, according to an embodiment of the present technology.

FIG. 7 illustrates an example of a computer system or computing device that can be utilized in various scenarios, according to an embodiment of the present technology.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the present technology described herein.

### DETAILED DESCRIPTION

Today, people often utilize computing devices (or systems) for a wide variety of purposes. For example, users can utilize computing devices to access a social networking system (or service). The users can utilize the computing devices to interact with one another, share content items, and view content items via the social networking system. For example, a user may share a content item, such as an image, a video, an article, or a link, via a social networking system. Other users may access the social networking system and interact with the shared content item.

Under conventional approaches, users can interact with other users through a social networking system or other type of communication platform. For example, a user can share a video to a social networking system, and other users may access the video via the social networking system. In this example, the video can include audio of the user singing. The user may be unhappy with the singing (e.g., the singing is off-key, the pitch is too low, the pitch is too high, etc.) and wish to adjust the singing. For example, the user can be singing along to a popular song and wish to adjust the singing to sound more like the popular song. However, conventional approaches fail to provide technologies to adjust the audio of the user singing. As a result, users can be discouraged from creating and sharing content items. Thus, conventional approaches are ineffective in addressing these and other problems arising in computer technology.

An improved approach rooted in computer technology overcomes the foregoing and other disadvantages associated with conventional approaches specifically arising in the realm of computer technology. In various embodiments, the present technology provides for generating tuned audio based on recorded audio (e.g., user-recorded singing) and source audio (e.g., published song) associated with the recorded audio. For example, a user can provide, as part of a video, recorded audio of the user singing a portion of a published song. The published song may have been first performed by another person, such as a professional singer or artist. Source audio, which in this example is the published song, can be identified based on the recorded audio. The recorded audio can be aligned with or matched to a portion of the source audio corresponding to what the user has sung. A transform of the recorded audio can be generated. The transform of the recorded audio can be, for example, a spectrogram of the recorded audio. A transform, such as a spectrogram, of the portion of the source audio that is aligned with the recorded audio can also be generated. Based on the spectrogram of the recorded audio and the spectrogram of the matching portion of the source audio, a spectrogram of tuned audio can be generated. The tuned audio can be generated based on the spectrogram of the tuned audio. In this example, the tuned audio can be the recorded audio tuned to match the key of the source audio. As further described herein, the present technology can generate tuned audio based on machine learning methodologies. For example, identification of source audio based on recorded audio can be based on one or more machine learning models. Generation of a spectrogram of tuned audio can also be based on one or more machine learning models. Further, generation of tuned audio based on a spectrogram of the tuned audio can also be based on one or more machine learning models. The present technology can be used, for example, to modify audio of a user singing a known song so that the audio is more faithful to or consistent with a standard version of the song or a version of the song first performed by another person. As just one example, the present technology can alter or correct the key of a song incorrectly sung by a user. Many other applications of the present technology are possible. More details relating to the present technology are provided below.

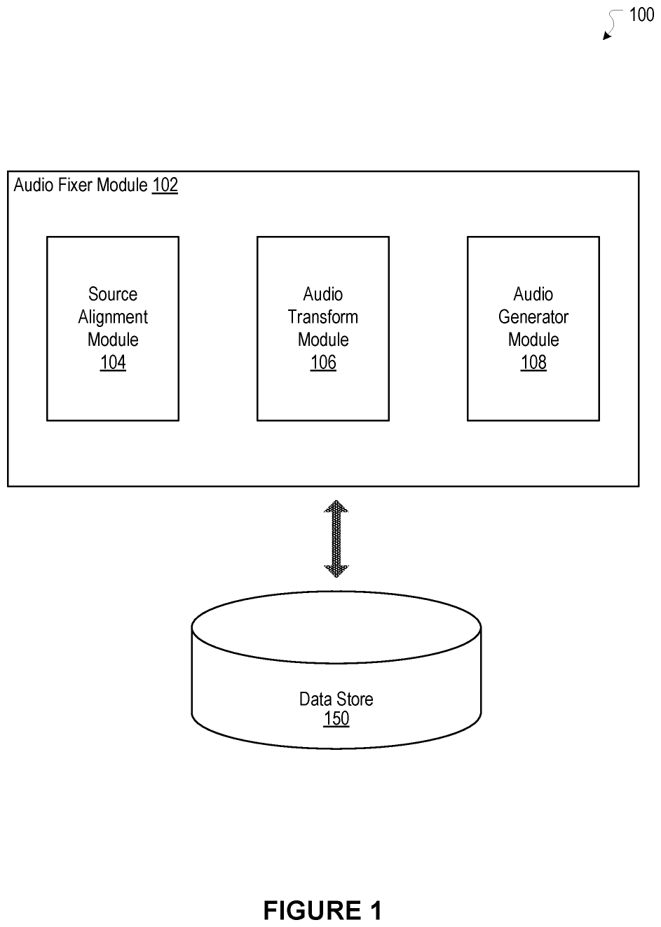

FIG. 1 illustrates an example system 100 including an audio fixer module 102, according to an embodiment of the present technology. As shown in the example of FIG. 1, the audio fixer module 102 can include a source alignment module 104, an audio transform module 106, and an audio generator module 108. In some instances, the example system 100 can include at least one data store 150 in communication with the audio fixer module 102. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the source alignment module 104, the audio transform module 106, and the audio generator module 108 can be implemented in any suitable combinations.

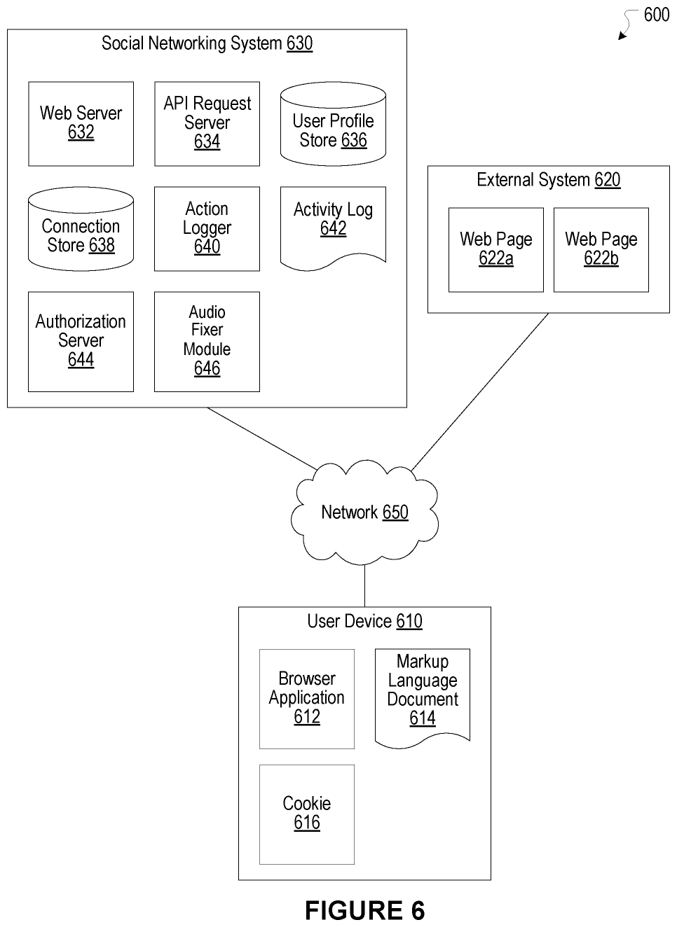

In various embodiments, the audio fixer module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some instances, the audio fixer module 102 can be, in part or in whole, implemented as software running on one or more computing devices or systems, such as on a server system or a client computing device. In some instances, the audio fixer module 102 can be, in part or in whole, implemented within or configured to operate in conjunction with or be integrated with a social networking system (or service), such as a social networking system 630 of FIG. 6. Likewise, in some instances, the audio fixer module 102 can be, in part or in whole, implemented within or configured to operate in conjunction with or be integrated with a client computing device, such as the user device 610 of FIG. 6. For example, the audio fixer module 102 can be implemented as or within a dedicated application (e.g., app), a program, or an applet running on a user computing device or client computing system. The application incorporating or implementing instructions for performing functionality of the audio fixer module 102 can be created by a developer. The application can be provided to or maintained in a repository. In some instances, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

The audio fixer module 102 can be configured to communicate and/or operate with the data store 150, as shown in the example system 100. The data store 150 can be configured to store and maintain various types of data. In some implementations, the data store 150 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 150 can store information that is utilized by the audio fixer module 102. For example, the data store 150 can store information associated with recorded audio and source audio. It is contemplated that there can be many variations or other possibilities.

In various embodiments, the source alignment module 104 can identify a portion of source audio that aligns or matches with recorded audio. The recorded audio can be received from various sources. The recorded audio can be provided by a user, for example, through a recording device associated with the user. The recorded audio can be an audio content item created by the user or part of a video content item created by the user. In some cases, the recorded audio can be shared with the user by another user, for example, through a social networking system. The source alignment module 104 can use conventional techniques to identify and obtain source audio that corresponds to or is likely to correspond to recorded audio. For example, conventional services can identify to varying degrees of confidence a musical piece performed by an artist based on a recording of a user singing some part of the musical piece. Based on the recorded audio, a portion of the source audio that aligns with or corresponds to the recorded audio can be identified.

The source alignment module 104 can identify source audio, or a portion of that source audio, that aligns with or corresponds to recorded audio based on machine learning methodologies. As used herein, alignment relates to identification or determination of corresponding or matching content in both recorded audio and source audio. For example, if recorded audio relates to a user singing the first three lines of the chorus of a popular song first performed by a pop artist, alignment of the recorded audio with source audio would involve an identification of the first three lines of the chorus of the popular song as sung by the pop artist. A machine learning model can be trained to identify a portion of source audio that aligns with recorded audio. The machine learning model can be trained based on training data that includes recorded audio and portions of source audio. Positive training data can include recorded audio and portions of source audio that align with the recorded audio. Negative training data can include recorded audio and portions of source audio that do not align with the recorded audio. For example, positive training data can include recorded audio of a user singing a 10 second portion of a published song starting from the 1:00 minute mark in the published song. The positive training data can also include the 10 second portion of the published song from the 1:00 minute mark as the portion of source audio that aligns with the recorded audio.

The source alignment module 104 can apply a trained machine learning model to recorded audio to identify source audio, or a portion of the source audio, that aligns with the recorded audio. The trained machine learning can determine, for different portions of different source audio, a likelihood that the portion of source audio aligns with the recorded audio. The trained machine learning model can generate, for each portion of source audio, a score or other indication of the likelihood that the portion of the source audio aligns with the recorded audio. Based on the respective scores of each portion of source audio, the portion of source audio that aligns with the recorded audio can be identified. The identified portion of source audio can have the highest score or have the highest likelihood of aligning with the recorded audio as determined by the trained machine learning model. For example, a user can provide recorded audio of the user singing a chorus of a published song. Based on the recorded audio, respective scores for different portions of different source audio, such as those in a database of published songs, can be determined by a trained machine learning model. The portion of source audio with the highest score can be determined to be the most likely to align with the recorded audio. This portion of source audio can be identified to align with the recorded audio. In some cases, recorded audio can be adjusted based on a portion of source audio identified to align with the recorded audio. The recorded audio can be adjusted, for example, with respect to audio speed or audio length. For example, a nine second portion of source audio can be identified to align with recorded audio that is 10 seconds in length. The recorded audio can be adjusted to be nine seconds in length by adjusting the speed of the recorded audio or removing a portion of the recorded audio. Other examples are possible.

In some cases, a determination of a likelihood that source audio, or a portion of the source audio, aligns with recorded audio can be weighted based on metadata associated with the recorded audio. Recorded audio can, in some instances, be associated with metadata such as tags, hashtags, or comments. The metadata can include, for example, an identification of a song name, an album, a genre, lyrics, or an artist of source audio to which the recorded audio corresponds or aligns. For example, a user can upload a video with recorded audio of the user singing a portion of a published song. The user can tag the video with the artist and name of the published song. The tags of the artist and name of the published song can be used to identify the published song to which the recorded audio corresponds. Scores of portions of source audio can be weighted based on metadata associated with recorded audio. Portions of source audio associated with the metadata can be weighted more heavily and can be scored more highly than portions of source audio that are not associated with the metadata. For example, a user can upload recorded audio with hashtags identifying a published song that the user is singing in the recorded audio. Based on the recorded audio, a trained machine learning model can determine respective scores for different portions of different source audio. The scores can be weighted based on the hashtags. In this example, a first portion of source audio can be a portion from the published song that matches information reflected in the hashtags, and a second portion of source audio can be a portion from a different published song. The score of the first portion of source audio can be weighted higher than the score of the second portion of source audio. Based on the weighted score of the first portion of source audio, the first portion of source audio can be identified as aligning with the recorded audio. As another example, a user can upload recorded audio with hashtags indicating that the user is singing the chorus of a published song in the recorded audio. In determining respective scores for different portions of source audio, which in this example is the published song, scores of portions of the source audio that correspond to the chorus can be weighted higher than scores of portions of the source audio that do not correspond to the chorus. Based on the weighted scores of the portions of the source audio, a portion of source audio that corresponds to the chorus can be identified as aligning with the recorded audio. Other examples are possible.

In some cases, source audio, or a portion of the source audio, that is identified to align with recorded audio can be provided to a user, and the user can provide feedback. For example, user feedback can include whether the portion of source audio is correctly identified. A trained machine learning model can be further trained or refined based on the feedback provided by the user. Recorded audio and a portion of source audio that, based on user feedback, is correctly identified to align with the recorded audio can be positive training data for further training or refining the trained machine learning model. Recorded audio and a portion of source audio that, based on user feedback, is incorrectly identified to align with the recorded audio can be negative training data for further training or refining the trained machine learning model. In some cases, the trained machine learning model can be further trained or refined based on additional data, such as new published songs and new recorded audio of users singing the new published songs. Many variations are possible.

In various embodiments, the audio transform module 106 can generate a transform of tuned audio based on a transform of recorded audio and a transform of matching source audio. Audio can include recorded audio, source audio, a portion of the source audio, or tuned audio. A transform of audio can include, for example, a spectrogram, a Fourier transform, a numerical representation, a vector representation of the audio, or any other type of representation or transformation. In some cases, a transform of audio can be generated from the audio based on a function. For example, a spectrogram of audio can be generated based on a Short-Time Fourier Transform function applied to periodic samples of the audio. As another example, a Fourier transform of audio can be generated based on a Fast Fourier Transform function or Discrete Fourier Transform function applied to the audio. Other examples are possible.

The audio transform module 106 can generate a transform of tuned audio based on machine learning methodologies applied to a transform of recorded audio and a transform of source audio, or a portion of the source audio. A machine learning model can be trained to generate a transform of tuned audio based on a transform of recorded audio and a transform of a portion of source audio. The machine learning model can be trained based on training data that includes transforms of recorded audio and transforms of portions of source audio that align with the recorded audio. The machine learning model can be trained to reduce distance (e.g., L2 distance, L1 distance) between the transforms of recorded audio and the transforms of portions of source audio. The machine learning model can be trained to avoid overfitting or avoid minimizing the distance between the transforms of recorded audio and the transforms of portions of source audio to the point where the transforms of recorded audio and the transforms of portions of source audio are identical or close to identical (e.g., within a threshold difference value). The machine learning model can also be trained to dimensionally (e.g., audio speed, audio length) adjust the transforms of the recorded audio based on the transforms of portions of source audio. For example, if recorded audio includes a user singing a published song (or source audio) at a speed faster than the speed of the published song, the machine learning model can be trained to slow the recorded audio to match or approximate the speed of the published song. In some cases, recorded audio can be adjusted prior to generation of a transform of the recorded audio, as described above. Based on the training data, the machine learning model can generate transforms of tuned audio. Based on the transforms of tuned audio, various aspects of the training of the machine learning model, such as how much distance between the transforms of recorded audio and the transforms of portions of source audio to reduce, can be refined. For example, training data for training a machine learning model can include a spectrogram of recorded audio of a user singing a published song. The training data can also include a spectrogram of a portion of the published song that aligns with the recorded audio. The machine learning model can be trained to reduce or minimize a distance between the spectrogram of the recorded audio and the spectrogram of the portion of the published song in an embedding space of spectrograms. The machine learning model also can be trained not to reduce or minimize a distance between spectrograms of recorded audio and spectrograms of portions of source audio in the embedding space when the recorded audio and the portions of source audio are not aligned (not matched). The machine learning model can generate a transform of tuned audio based on the reduction in the distance. In some embodiments, the machine learning model can be selectively adjusted to vary the sound associated with the transform of tuned audio generated by the machine learning model so that the tuned audio can be more similar to the original sound of the recorded audio or the tuned audio can be more similar to the sound of the source audio. For example, the machine learning model can be adjusted to preserve to a selected degree the original singing or sound characteristics of the user. As another example, the machine learning model can be adjusted to modify to a selected degree the original singing or sound characteristics of the user to resemble the singing or sound characteristics of corresponding source audio. In some implementations, a machine learning model can be adjusted, for example, by removing parameters (e.g., properties, weights, connections) from evaluation by the machine learning model or by removing layers (e.g., from a neural network) so as to preserve certain characteristics of recorded audio. In one implementation, the machine learning model can be adjusted until tuned audio based on the transform of tuned audio sounds like the user is singing the published song in the correct key. Many variations are possible.

The audio transform module 106 can apply a trained machine learning model to a transform of recorded audio and a transform of corresponding source audio to generate a transform of tuned audio. The transform of recorded audio can be based on recorded audio provided by a user. A portion of source audio can be identified based on the recorded audio and can align with the recorded audio. The transform of the portion of source audio can be based on the identified and aligned portion of source audio. The trained machine learning model can generate a transform of tuned audio based on the transform of the recorded audio provided by the user and the transform of the identified and aligned portion of source audio. For example, a user can record a video that includes recorded audio of the user singing a published song. A portion of source audio that aligns with the recorded audio can be identified. A recorded audio spectrogram (or other transform) can be generated from the recorded audio. A source audio spectrogram (or other transform) can be generated from the portion of source audio. The recorded audio spectrogram and the source audio spectrogram can be provided to a trained machine learning model. The trained machine learning model can generate a tuned audio spectrogram based on the recorded audio spectrogram and the source audio spectrogram. As one example, the tuned audio spectrogram can be a spectrogram of the user singing the published song in the key of the published song. Tuned audio of the user singing the published song can be generated based on the tuned audio spectrogram. In some cases, a trained machine learning model can generate a tuned audio spectrogram based on a recorded audio spectrogram of recorded audio. The tuned audio spectrogram can be a spectrogram of the recorded audio tuned to be in key. In this case, the trained machine learning model can generate the tuned audio spectrogram without a source audio spectrogram.

In various embodiments, the audio generator module 108 can generate audio, such as tuned audio, from a transform, such as a tuned audio transform. In some cases, audio can be generated from a transform based on an inverse function. For example, a tuned audio spectrogram can be generated from a recorded audio spectrogram and a source audio spectrogram. The recorded audio spectrogram and the source audio spectrogram can be generated from a function, such as a Short-Time Fourier Transform function, applied to recorded audio and a portion of source audio. In this example, tuned audio can be generated from the tuned audio spectrogram based on an inverse Short-Time Fourier Transform function.

In some cases, the audio generator module 108 can generate audio from a transform based on machine learning methodologies. A machine learning model (e.g., generative model) can be trained to generate audio based on a transform. The machine learning model can be trained based on training data that includes audio and transforms of the audio. For example, a function can be applied to a published song to generate a transform of the published song. The transform of the published song and the published song can be included in training data for training a machine learning model. In some cases, a machine learning model can be trained based on training data that includes audio associated with attributes and transforms of the audio. The attributes can include, for example, an artist, a genre, a musical style, etc. Training the machine learning model based on training data that includes audio associated with particular attributes can allow the machine learning model to generate audio associated with the attributes. For example, a machine learning model can be trained with training data that includes audio associated with a particular musical style, such as rock music singing, robotic singing, jazz singing, kids singing, etc., and transforms of the audio. Based on the training data, the machine learning model can be trained to generate audio that sounds like, for example, rock music. While in this example the machine learning model is trained to generate audio that sounds like a particular musical style , in other implementations, a machine learning model can be trained to generate audio associated with, for example, a particular artist or a particular genre. In some cases, attributes associated with audio and transforms of the audio can be included in training data for training a machine learning model. The machine learning model can be trained to accept the attributes as input and generate audio associated with an inputted attribute. In some embodiments, a machine learning model can be trained based on training data that includes audio, transforms of the audio, and text (e.g., lyrics) associated with the audio. Training the machine learning model based on training data that includes audio, transforms of the audio, and text associated with the audio can allow the machine learning model to generate audio for inputted text. The generated audio can include, for example, singing of the inputted text.

The audio generator module 108 can apply a trained machine learning model to a transform of audio, such as a transform of tuned audio, and generate audio, such as tuned audio, based on the transform of audio. In some cases, the trained machine learning model can generate audio based on inputs, such as text or features, in addition to the transform of audio. For example, a transform of tuned audio can be generated based on recorded audio and a portion of source audio that aligns with the recorded audio. Based on the transform of tuned audio, a trained machine learning model can generate tuned audio. In this example, the tuned audio can sound like the recorded audio adjusted to the key of the portion of source audio. The trained machine learning model can also accept, as input, lyrics associated with portion of source audio. In this example, the recorded audio can include incorrectly sung lyrics and the tuned audio can sound like the recorded audio adjusted to the key of a matching portion of source audio with correctly sung lyrics.

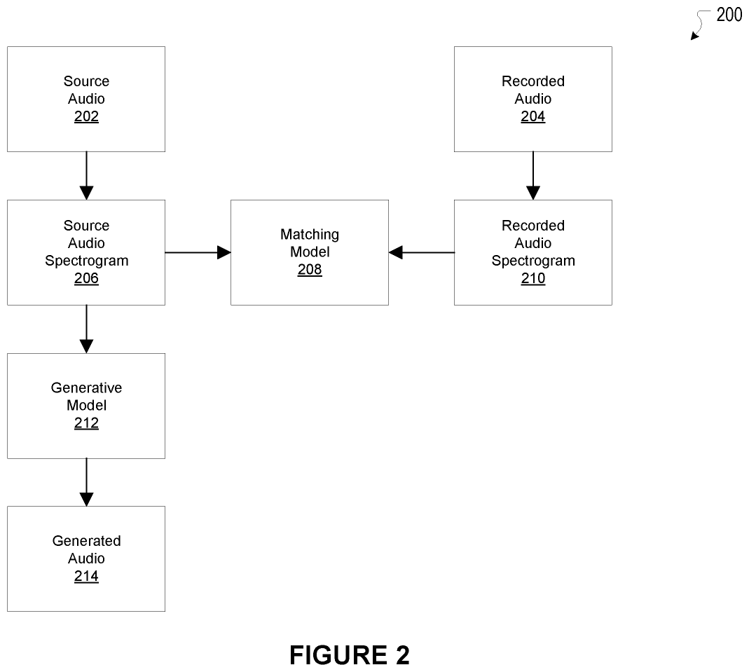

FIG. 2 illustrates an example functional block diagram 200, according to an embodiment of the present technology. The example functional block diagram 200 illustrates an example machine learning training process that can be performed or facilitated by the audio fixer module 102 of FIG. 1. It should be understood that there can be additional, fewer, or alternative steps performed in similar or alternative orders, or in parallel, based on the various features and embodiments discussed herein unless otherwise stated.

As illustrated in the example functional block diagram 200, training data for training a machine learning model can include source audio 202 and recorded audio 204. The source audio 202 can be, for example, a published song. The recorded audio 204 can be, for example, audio of a user singing the published song. Based on the source audio 202, a source audio spectrogram 206 can be generated. The source audio spectrogram 206 can be generated, for example, based on a spectrogram function as described above. Based on the recorded audio 204, a recorded audio spectrogram 210 can be generated. The source audio spectrogram 206 and the recorded audio spectrogram 210 can be provided to a matching model 208 as training data for training the matching model 208. The training of the matching model 208 can include, for example, reducing a distance (e.g., L2 distance, L1 distance) between the source audio spectrogram and the recorded audio spectrogram 210 to generate a tuned audio spectrogram. As discussed, the matching model 208 can be adjusted to vary the degree to which the generated audio 214 sounds like the source audio 202 versus the recorded audio 204. The source audio spectrogram can also be provided to a generative model 212 as training data for training the generative model 212. The generative model 212 can be trained to produce generated audio 214 that is a modification of the recorded audio 204 to sound more like the source audio 202. All examples herein are provided for illustrative purposes, and there can be many variations and other possibilities.

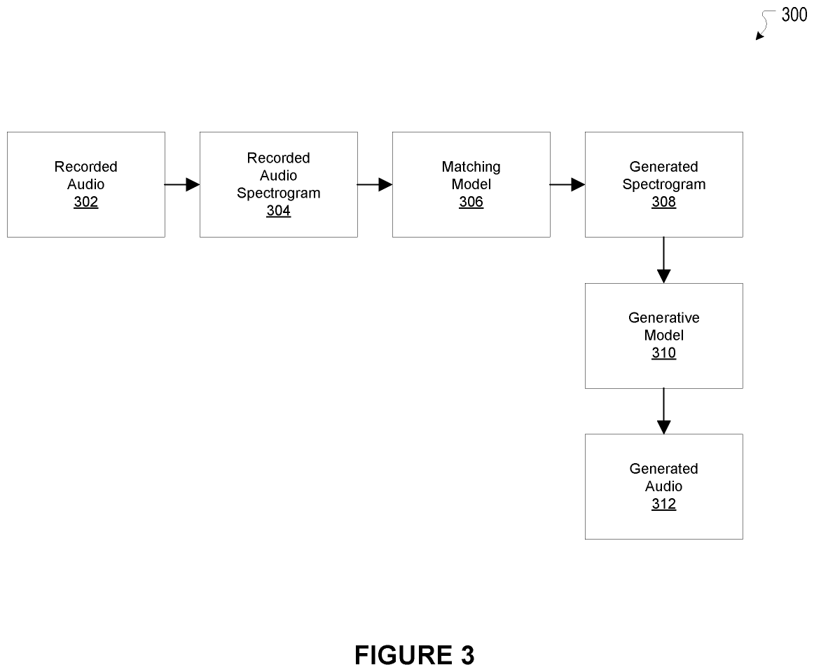

FIG. 3 illustrates an example functional block diagram 300, according to an embodiment of the present technology. The example functional block diagram 300 illustrates an example machine learning evaluation process that can be performed or facilitated by the audio fixer module 102 of FIG. 1. It should be understood that there can be additional, fewer, or alternative steps performed in similar or alternative orders, or in parallel, based on the various features and embodiments discussed herein unless otherwise stated.

As illustrated in the example block diagram 300, recorded audio 302 can be provided, for example, by a user. Based on the recorded audio 302, a recorded audio spectrogram 304 can be generated. The recorded audio spectrogram 304 can be provided to a matching model 306. A portion of source audio that aligns with the recorded audio 302 can be identified, and a spectrogram of the portion of source audio can be provided to the matching model 306. Based on the spectrogram of the portion of source audio and the recorded audio spectrogram 304, the matching model 306 can generate a generated spectrogram 308. The generated spectrogram 308 can be, for example, a spectrogram of tuned audio. The generated spectrogram 308 can be provided to a generative model 310. The generative model 310 can produce generated audio 312. The generated audio 312 can be, for example, the tuned audio. The generated audio 312, or tuned audio, can be a modification or correction of the recorded audio 302 to sound more like the portion of source audio to a certain degree. For example, the tuned audio can sound like the recorded audio 302 tuned to the key of the portion of source audio. All examples herein are provided for illustrative purposes, and there can be many variations and other possibilities.

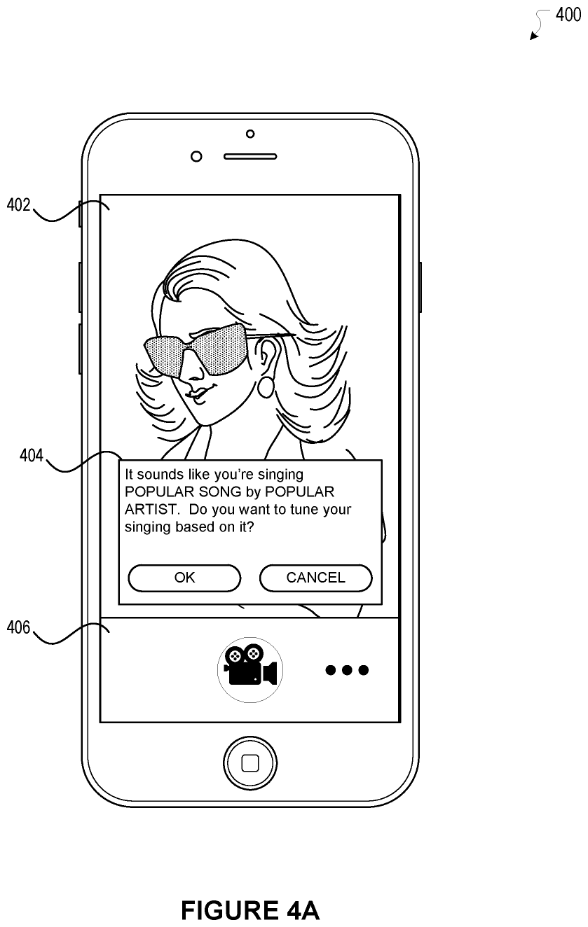

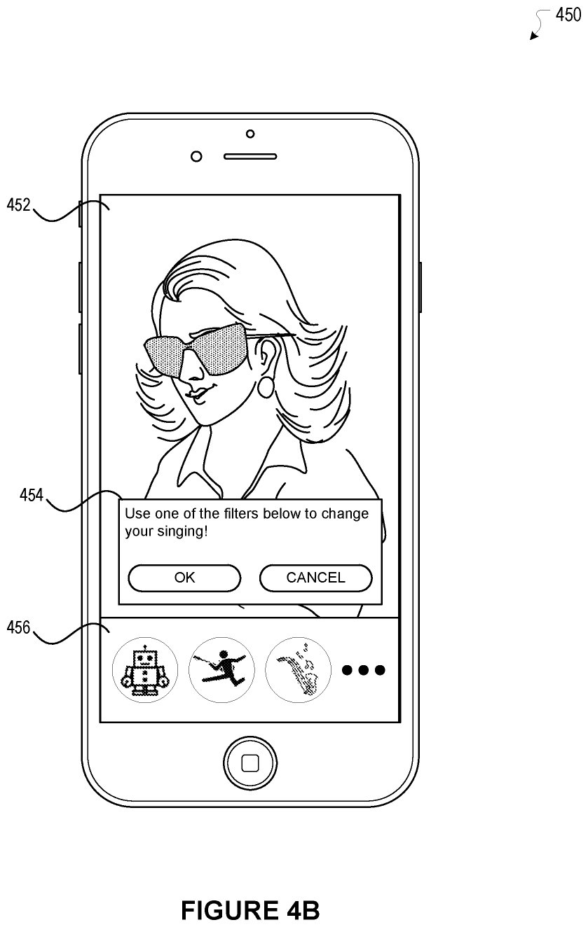

FIGS. 4A-4B illustrate example interfaces generated by computing devices associated with users, according to an embodiment of the present technology. The example interfaces can be associated with one or more functionalities performed by the audio fixer module 102 of FIG. 1. In some cases, the example interface of FIG. 4B can be provided in response to an interaction with the example interface of FIG. 4A. It should be understood that there can be additional, fewer, or alternative steps performed in similar or alternative orders, or in parallel, based on the various features and embodiments discussed herein unless otherwise stated.

FIG. 4A illustrates an example interface 400, according to an embodiment of the present technology. The example interface 400 can be provided, for example, in response to a user recording a video 402 that includes recorded audio. The example interface 400 can include the video 402 recorded by the user. In this example, the recorded audio in the video 402 can include the user singing a popular song by a popular artist. The example interface 400 can include a message 404 that indicates that source audio (e.g., POPULAR SONG by POPULAR ARTIST) that aligns with the recorded audio has been identified. The message 404 can include an invitation to tune the recorded audio based on the source audio. The example interface 400 can include a section 406 for various video recording tools to, for example, capture or edit additional video content that includes singing by the user. All examples herein are provided for illustrative purposes, and there can be many variations and other possibilities.

FIG. 4B illustrates an example interface 450, according to an embodiment of the present technology. The example interface 450 can be provided, for example, in response to a user selecting an option to tune recorded audio in a video 452 based on source audio. In some cases, the example interface 450 can be provided in response to the user selecting an option to tune the recorded audio in the message 404 in the example interface 400 of FIG. 4A. Upon selection of the option, the recorded audio can be appropriately tuned based on the source audio according to the techniques discussed herein. In this example, the example interface 450 can include the video 452 that includes tuned audio based on the recorded audio in the video 452 and the source audio. The example interface 450 can include a message 454 that indicates that the tuned audio can be further modified with one or more filters. The example interface 450 can include a section 456 for various filters for modifying the tuned audio. For example, the filters can include a robot filter to modify the tuned audio to sound robotic. The filters can also include a rock filter to modify the tuned audio to sound like a rock song. The filters can also include a jazz filter to modify the tuned audio to sound like a jazz song. All examples herein are provided for illustrative purposes, and there can be many variations and other possibilities.

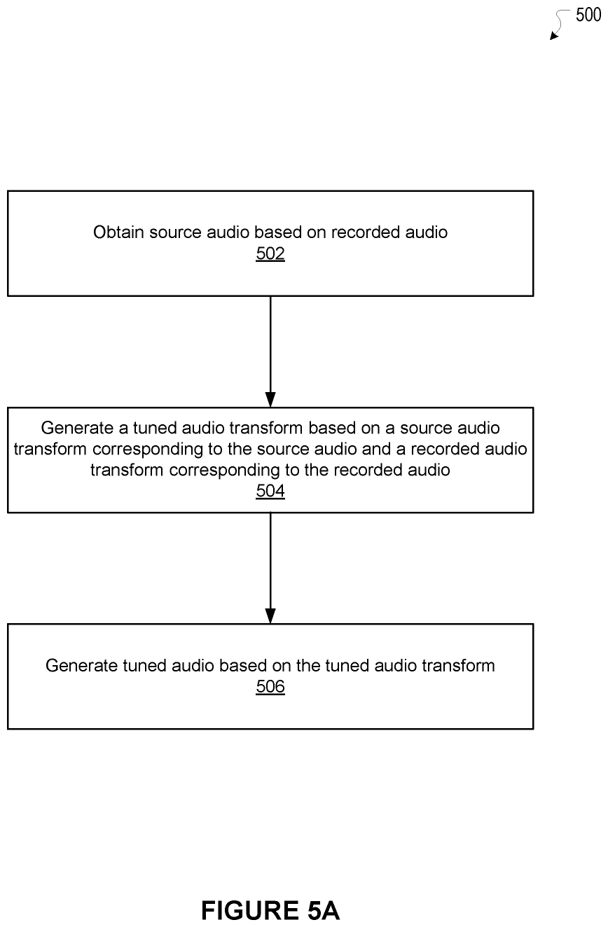

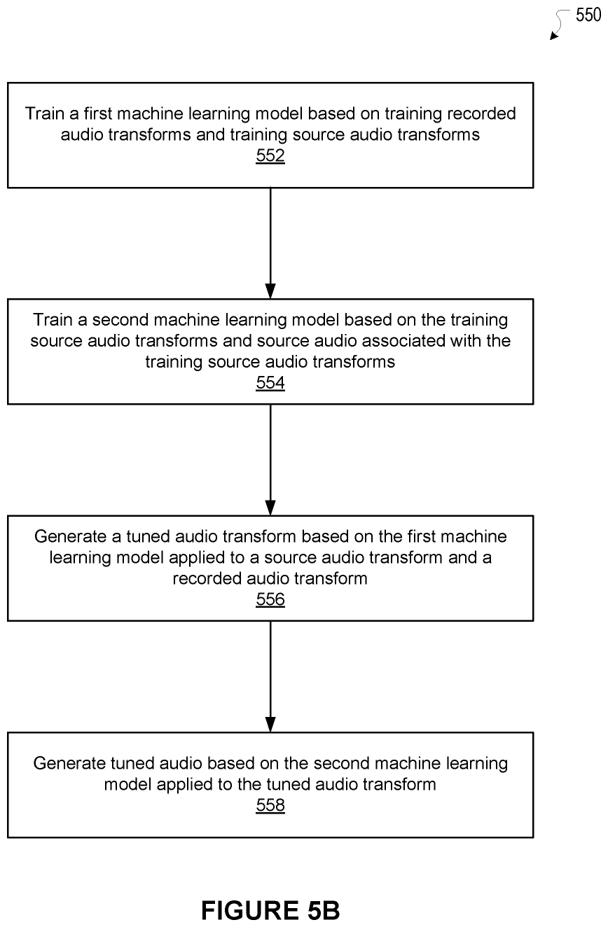

FIG. 5A illustrates an example method 500, according to an embodiment of the present technology. It should be understood that there can be additional, fewer, or alternative steps performed in similar or alternative orders, or in parallel, based on the various features and embodiments discussed herein unless otherwise stated. At block 502, the example method 500 obtains source audio based on recorded audio. At block 504, the example method 500 generates a tuned audio transform based on a source audio transform corresponding to the source audio and a recorded audio transform corresponding to the recorded audio. At block 506, the example method 500 generates tuned audio based on the tuned audio transform.

FIG. 5B illustrates an example method 550, according to an embodiment of the present technology. It should be understood that there can be additional, fewer, or alternative steps performed in similar or alternative orders, or in parallel, based on the various features and embodiments discussed herein unless otherwise stated. At block 552, the example method 550 trains a first machine learning model based on training recorded audio transforms and training source audio transforms. At block 554, the example method 550 trains a second machine learning model based on the training source audio transforms and source audio associated with the training source audio transforms. At block 556, the example method 550 generates tuned audio transform based on the first machine learning model applied to a source audio transform and a recorded audio transform. At block 558, the example method 550 generates a tuned audio based on the second machine learning model applied to the tuned audio transform.

It is contemplated that there can be many other uses, applications, and/or variations associated with the various embodiments of the present technology. For example, in some cases, a user can choose whether or not to opt-in to utilize the present technology. The present technology can also ensure that various privacy settings and preferences are maintained and can prevent private information from being divulged. In another example, various embodiments of the present technology can learn, improve, and/or be refined over time.

### Social Networking System—Example Implementation

FIG. 6 illustrates a network diagram of an example system 600 that can be utilized in various scenarios, according to an embodiment of the present technology. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include an audio fixer module 646. The audio fixer module 646 can be implemented with the audio fixer module 102, as discussed in more detail herein. In various embodiments, some or all functionality of the audio fixer module 102 can be additionally or alternatively implemented by the user device 610. It should be appreciated that there can be many variations or other possibilities.

### Hardware Implementation

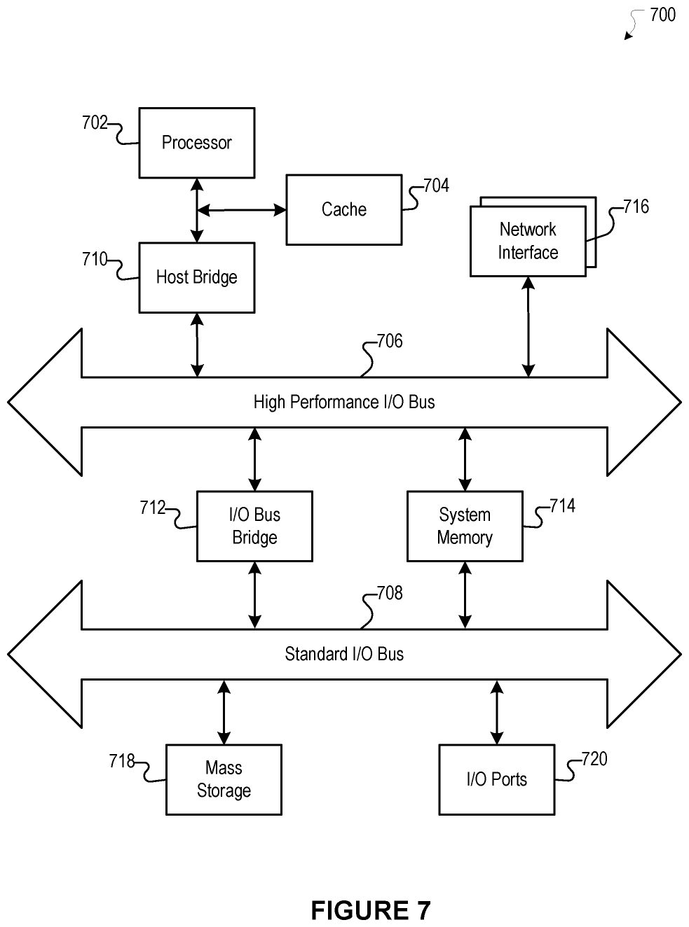

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the technology can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the present technology. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method comprising:
obtaining, by a computing system, source audio based on recorded audio;
generating, by the computing system, a tuned audio transform based on a source audio transform corresponding to the source audio and a recorded audio transform corresponding to the recorded audio; and
generating, by the computing system, tuned audio based on the tuned audio transform

2. The computer-implemented method of claim 1, further comprising training a first machine learning model based on training data including recorded audio transforms and source audio transforms, wherein the generating the tuned audio transform is based on the first machine learning model applied to the source audio transform and the recorded audio transform.

3. The computer-implemented method of claim 2, wherein the training the first machine learning model is based on a reduction in distance between the recorded audio transforms and the source audio transforms in an embedding space.

4. The computer-implemented method of claim 1, further comprising training a second machine learning model based on training data including source audio transforms and source audio associated with the source audio transforms, wherein the generating the tuned audio is based on the second machine learning model applied to the tuned audio transform.

5. The computer-implemented method of claim 4, wherein the training the second machine learning model is further based on an attribute associated with the source audio, wherein the attribute includes at least one of: an artist, a genre, or a musical style.

6. The computer-implemented method of claim 5, wherein the generating the tuned audio is further based on the attribute.

7. The computer-implemented method of claim 1, wherein the obtaining the source audio further comprises determining a portion of the source audio that aligns with the recorded audio.

8. The computer-implemented method of claim 7, wherein the determining a portion of the source audio that aligns with the recorded audio is based on metadata associated with the recorded audio.

9. The computer-implemented method of claim 8, wherein the metadata is associated with one or more of a song name, an album, a musical genre, lyrics, or an artist associated with the source audio.

10. The computer-implemented method of claim 1, wherein the tuned audio is based on the recorded audio tuned to a key of the source audio.

11. A system comprising:
at least one processor; and
a memory storing instructions that, when executed by the at least one processor, cause the system to perform:
obtaining source audio based on recorded audio;
generating a tuned audio transform based on a source audio transform corresponding to the source audio and a recorded audio transform corresponding to the recorded audio; and
generating tuned audio based on the tuned audio transform.

12. The system of claim 11, further comprising training a first machine learning model based on training data including recorded audio transforms and source audio transforms, wherein the generating the tuned audio transform is based on the first machine learning model applied to the source audio transform and the recorded audio transform.

13. The system of claim 12, wherein the training the first machine learning model is based on a reduction in distance between the recorded audio transforms and the source audio transforms in an embedding space.

14. The system of claim 11, further comprising training a second machine learning model based on training data including source audio transforms and source audio associated with the source audio transforms, wherein the generating the tuned audio is based on the second machine learning model applied to the tuned audio transform.

15. The system of claim 14, wherein the training the second machine learning model is further based on an attribute associated with the source audio, wherein the attribute includes at least one of: an artist, a genre, or a musical style.

16. A non-transitory computer-readable storage medium including instructions that, when executed by at least one processor of a computing system, cause the computing system to perform:
obtaining source audio based on recorded audio;
generating a tuned audio transform based on a source audio transform corresponding to the source audio and a recorded audio transform corresponding to the recorded audio; and
generating tuned audio based on the tuned audio transform

17. The non-transitory computer-readable storage medium of claim 16, further comprising training a first machine learning model based on training data including recorded audio transforms and source audio transforms, wherein the generating the tuned audio transform is based on the first machine learning model applied to the source audio transform and the recorded audio transform.

18. The non-transitory computer-readable storage medium of claim 17, wherein the training the first machine learning model is based on a reduction in distance between the recorded audio transforms and the source audio transforms in an embedding space.

19. The non-transitory computer-readable storage medium of claim 16, further comprising training a second machine learning model based on training data including source audio transforms and source audio associated with the source audio transforms, wherein the generating the tuned audio is based on the second machine learning model applied to the tuned audio transform.

20. The non-transitory computer-readable storage medium of claim 19, wherein the training the second machine learning model is further based on an attribute associated with the source audio, wherein the attribute includes at least one of: an artist, a genre, or a musical style.
